(19) United States
(12) Patent Application Publication
(10) Pub. No.: US 2007/0240912 A1
(43) Pub. Date: Oct. 18, 2007

(54) Bed-Top Scale

(76) Inventor: Elias Papazissis, Rafina (GR)

Correspondence Address: BROOKS KUSHMAN P.C., 1000 TOWN CENTER, TWENTY-SECOND FLOOR, SOUTHFIELD, MI, 48075, US

(21) Appl. No.: 10/596,173

(22) PCT Filed: Dec. 2, 2004
(86) PCT No.: PCT/GR04/00056

§ 371 Date: Jan. 22, 2007

(30) Foreign Application Priority Data
Dec. 2, 2003 (GR) 20030100504

(51) Int. Cl. G01G 21/23; G01G 21/28

(52) U.S. Cl. 177/126; 177/244

(57) ABSTRACT

The present invention provides a bed-top scale for humans, that is a system for weighing the body weight of patients lying in a horizontal position, which comprises a stretcher (1, 2), a strap (9, 10) for suspending the stretcher (1, 2) and a means (35) of weighing. Such weighing means may be a weighing beam (3) that has support members (28). The weighing beam and the support members are positioned astride, over the patient, and the members, on either side of the patient's torso and the stretcher (1, 2), are supported on the surface on which the patient is lying (e.g. mattress). The stretcher (1, 2) is positioned under the patient, and weighing is effected by suspending the stretcher with the patient from the weighing beam (3).

### FIELD OF THE INVENTION

The present invention refers to the measurement with a scale of the body weight of patients lying in a horizontal position.

### STATE OF THE ART

The regular measurement of the body weight of patients is necessary for monitoring possible rapid increase or loss of weight.

Since the mass of adipose and muscle tissues varies slowly, any rapid change of the body weight practically reflects a change of the body-water content. Body-water content constitutes approximately 60% of the body weight. Thus, the body weight is an extremely sensitive index of the water balance. Its close monitoring allows for early diagnosis and treatment of the onset of liquid overloading or, on the other hand, the onset of dehydration.

This monitoring is of vital importance especially for patients, whose water balance is extensively disturbed, such as elderly people, patients with renal failure, patients suffering from diabetes mellitus and from many other diseases.

For patients incapable of standing on the usual human scales, it is necessary to provide a system that will allow their weighing in a non-standing position.

For the weighing of patients in a non-standing position, scales in the form of armchairs are currently used in practice. However, a prerequisite for using these scales is that the patient is able to sit upright. Therefore, their practical usefulness is significantly limited for patients lacking this ability. One further disadvantage of such scales is that they cannot be easily transported, since they are bulky and heavy. This makes them inconvenient for home-care nursing of patients.

For the weighing of patients in bed-top/horizontal position, several known scales of different kinds are available today.

Such scales are those integrated in hospital beds. In practice, such scale-beds are intended for use in nephrological and other hospital units. Obviously, this scale is a whole bed that is capable of weighing only the person occupying it during his hospitalisation in that particular unit. Thus, the use of such scales cannot be extended to all the patients of the hospital or clinic, and also they cannot be used for patients that are not in the hospital.

Another kind of scale used for weighing patients in horizontal/bed-top position are scales which function as cranes. The disadvantages of such scales are that they are bulky, heavy and hard to move. Furthermore, their purchase cost is high. More importantly, such scales require that the patient is lying on a bed with legs, that is, that there is a gap between the bedstead and the floor, so that the base of the scale-crane can be positioned under the bed. As a consequence, such scales are not convenient when the patient is lying on a bed built flush to the floor (e.g. ottoman-type bed, concrete-based, storage-based or several mattresses one on top of the other), which is a frequent case in home-care.

Yet another kind of scale used for weighing patients in bed-top position, is that which is placed under the rollers of the bed and weighs both the patient and the bed. In this case, it is obvious that in order to determine the patient's weight the tare must be constant. Thus, these scales are not convenient for weighing patients that are lying on many different kinds of beds with unknown tare. In such cases before weighing, the patient must be removed from the bed in order to measure the tare, which makes weighing inconvenient. Furthermore, whether in hospital or not, such scales require a bed with rollers or legs, the dimensions of which are small enough to fit in the scale's specially formed cup-like receptacles. Obviously, such scales can not be used in home-care nursing, where the bed is usually without rollers and varies both in respect to the shape of the bedstead and in respect to its weight.

There are also scales for weighing patients in bed-top position, which have elements that are positioned as transverse beams under the mattress from head to foot. Such scales have the disadvantage that they are not easily placed in or removed from the patients' beds, as it is necessary to remove the patient and the mattress in order to position the weighing mechanism. Therefore, one scale is needed for each patient. Furthermore, such scales are not suitable for use with beds where the positioning of the scale's elements under the mattress is difficult. For example double beds, bed-armchairs or beds of a special kind require the frame on which the mattress is supported to be of a width which coincides with the size of the scale's elements.

It is obvious that such scales are not suitable for home-care nursing, where many different kinds of beds may be encountered and where the transport of bulky and heavy weighing mechanisms from home to home is not practical. However, even in hospitals, where space allows the transport of wheeled crane-type scales, their use is extremely limited, and thus, they are not convenient for routine use.

It is therefore necessary to provide for a system for weighing humans lying in bed, which is convenient, light-weight, suitable for use with any kind of bed and especially, suitable for weighing different people successively, irrespective of where they are accommodated, including home-care nursing.

### SUMMARY OF THE INVENTION

The present invention provides a bed-top scale for humans, that is, a system for measuring the body weight (weighing) of patients lying in horizontal position, which comprises a stretcher and a means for weighing the patient.

The characteristic element of the bed-top scale is that the scale is positioned by means of support members on top of the surface on which the patient is lying, that is, on the mattress itself, on top of the patient's bed.

The weighing system proposed by the present invention comprises the following basic parts: a stretcher on which the patient is positioned, a strap for suspending the stretcher and a means for weighing. The weighing means proposed by the present invention comprise a weighing beam which has support members.

The weighing beam and support members, which expand to a [symbol] -shape configuration, are positioned astride the patient. The members on either side of the patient's torso, are supported on the surface on which he is lying (e.g. mattress), by bases. Preferably, these bases are collapsible. The stretcher, while being assembled, is positioned under the patient. Weighing is effected by suspending the stretcher with the patient from the weighing beam.

In this way, the scale (the weighing system) provided by the invention allows the weighing of patients lying on a bed of any kind, and having any type of bedstead, even on a single mattress.

The weighing system of the present invention functions as follows:

A stretcher, which can be assembled and collapsed for transport is positioned under the patient. A strap is fastened to the stretcher and is then attached to the weighing beam by means of a cable (e.g. by a hook). Thereafter, the cable winds up inside the weighing beam by a pulley system, is pulled into the weighing beam and lifts the stretcher with the patient, until the stretcher is not touching the bed. The (preferably electronic) dynamometer which is integrated in the weighing beam provides the cable tension. After the weight of the stretcher and of the strap are substracted from this tension, the weight of the patient is determined.

The weighing system disclosed by the present invention is convenient to use, can be operated by only one person, does not require special muscle strength or body structure to be operated. The whole process of weighing the patient is fast, lasting only a few minutes. Also, this weighing system is light, can be easily transported by one person only and is suitable for the sequential weighing of many different patients in hospitals, in long-term treatment facilities (hospices) or in home-care. The weighing of patients with the bed-top scale for humans (the weighing system) disclosed by the present invention may by repeated so often as necessary without any difficulty.

A particular advantage of the invention is that the proposed bed-top weighing system can be used outside a hospital setting, that is in private houses and facilities, which makes it suitable for use in home-care nursing.

According to one embodiment of the present invention, this system is foldable, with parts which can be dismantled and positioned in a small space for storage and transport.

### DESCRIPTION OF THE DRAWINGS

The invention is illustrated in the drawings, in which:

FIG. 1 shows the two parts (1 and 2) of a metallic break-apart stretcher which can be folded, in compact form. FIG. 1 also shows a weighing beam (3) with foldable support members in compact form. The above are components of the scale disclosed by the invention. A carrying case is also shown. Alternatively, instead of a break-apart foldable stretcher, a collapsible soft stretcher can be used.

FIGS. 2a and 2b illustrate how the parts (1, 2) of the break-apart (foldable) metallic stretcher are opened out with the joints (5) of the stretcher, the fins (4) of the stretcher and the joints (6) between the two parts (1, 2) of the stretcher.

FIG. 3a shows the fastening loops (7) of the proposed break-apart (foldable) metallic stretcher and the counter-supports (8) of the fastening loops.

FIG. 3b shows how the joints between the two parts of the stretcher are secured.

FIG. 4 shows the suspension strap mounted on the fastening loops of the metallic stretcher. The strap has a central long part (9) and four members (10), each end of which is attached with special components at the fastening loops (7).

FIG. 5a shows the collapsible tubing frame of a collapsible soft stretcher in storage configuration, where it occupies the smallest possible space. Components (11) and (12) are the non-collapsible short sides of the stretcher. The long sides (13) of the collapsible tubing frame are seen in compact storage form, where the various parts, which can be of circular or orthogonal (bent) cross-section, are contained one within the other in decreasing order of cross-sectional diameter, and can be telescopically expanded. Here provision must be made in order to avoid disconnection of the parts one from the other and to secure them in stretched configuration.

FIG. 5b shows how the assemblage of the tubing frame starts. It can be seen that the parts (11) and (12) are positioned at a distance from each other. The tubing parts that constitute the long sides (13) of the stretcher are seen in compact form, i.e. placed one within the other. Components labelled (7), are the loops of the parts (11) and (12) of the frame, to which the suspension strap will be fastened.

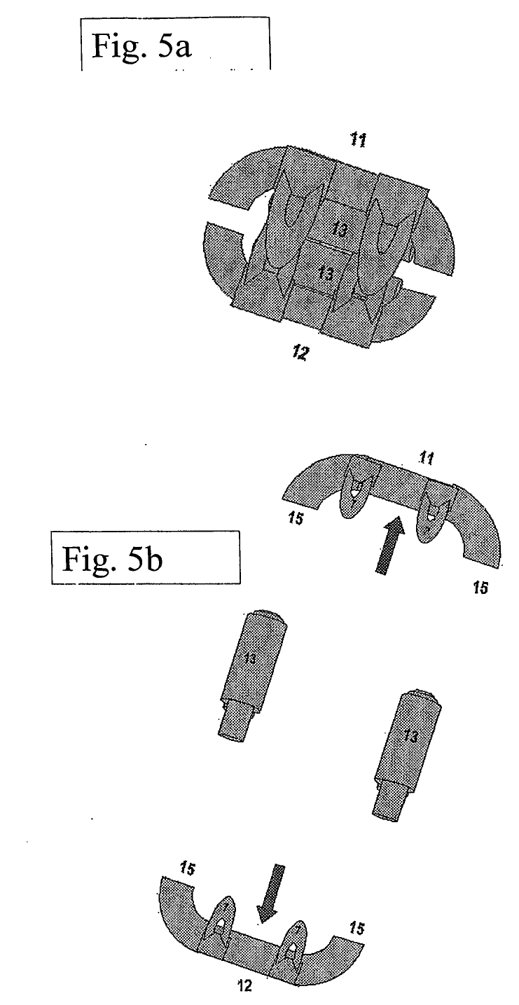

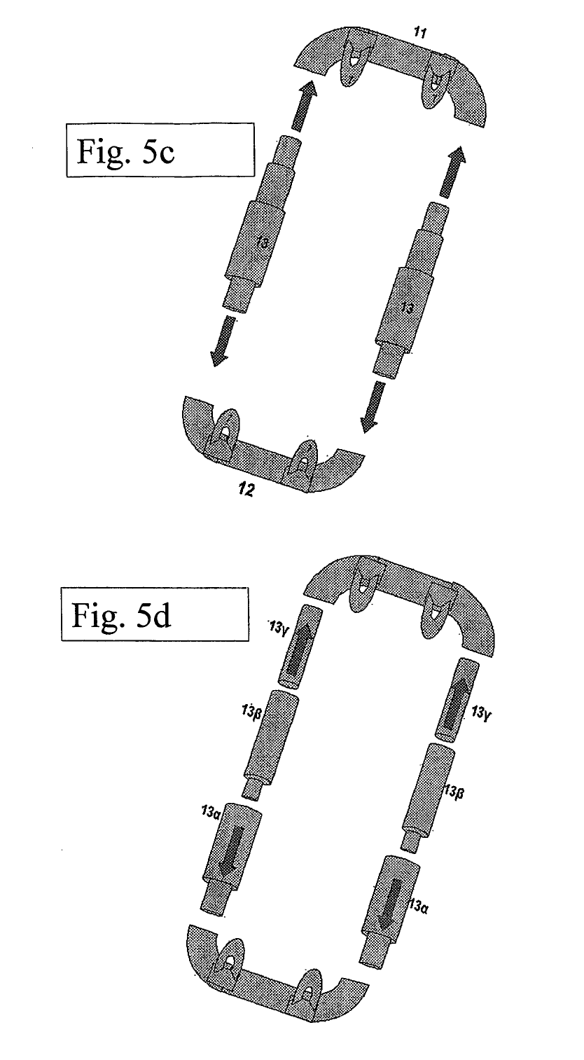

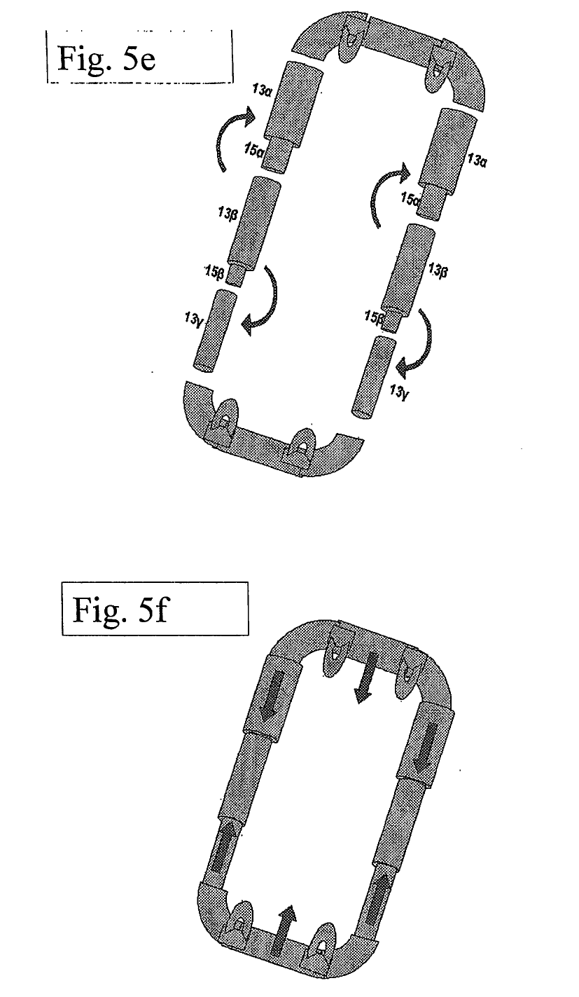

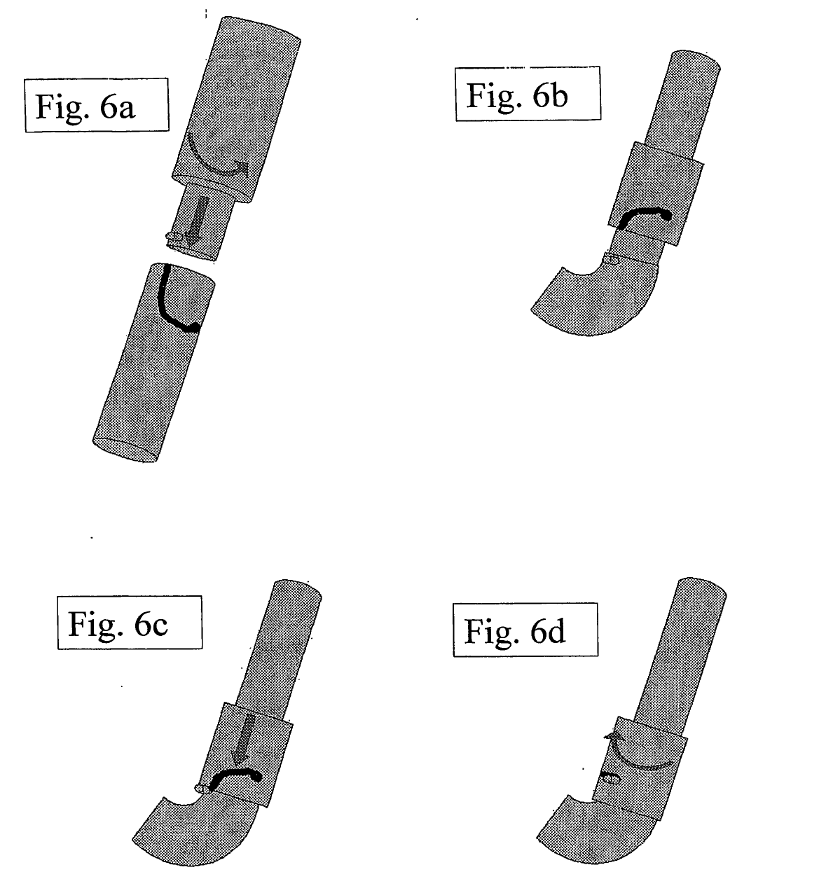

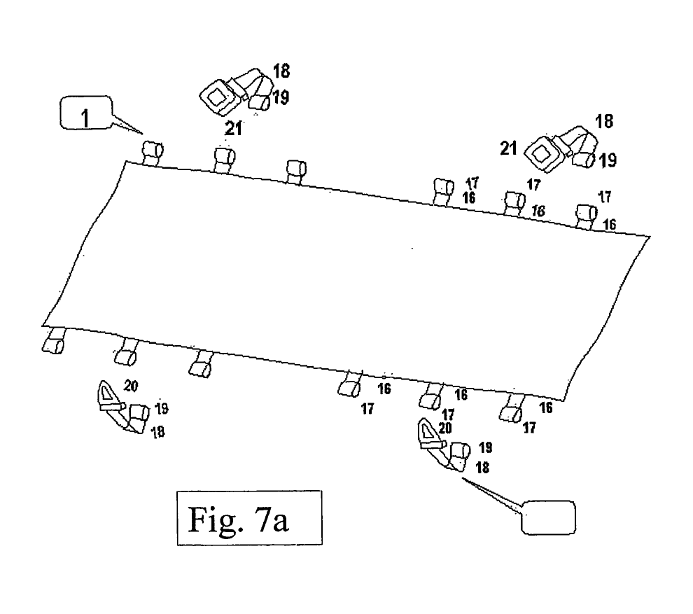

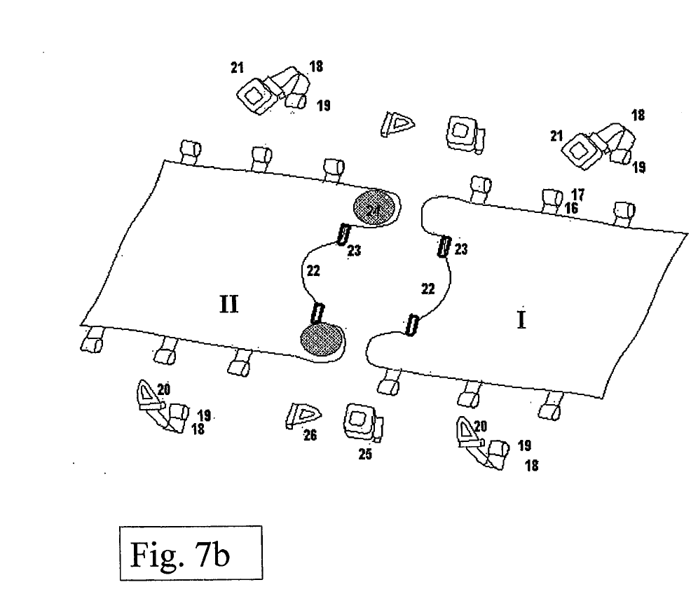

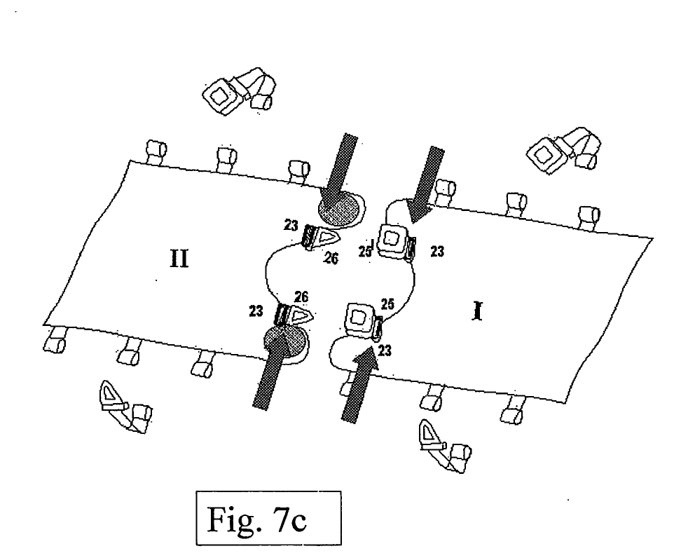

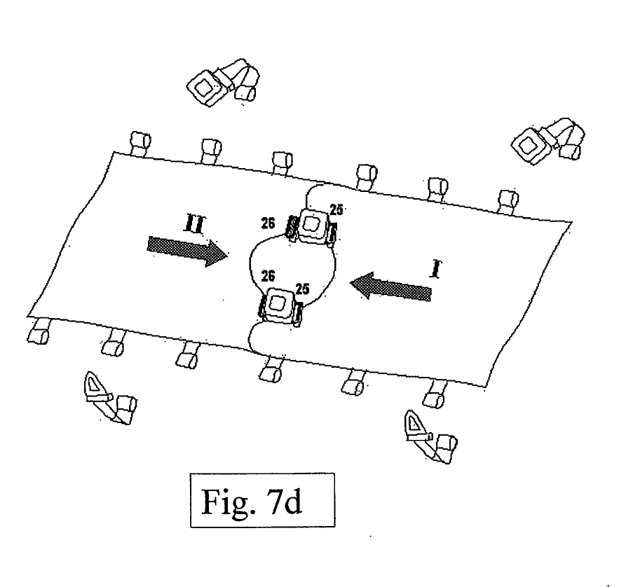

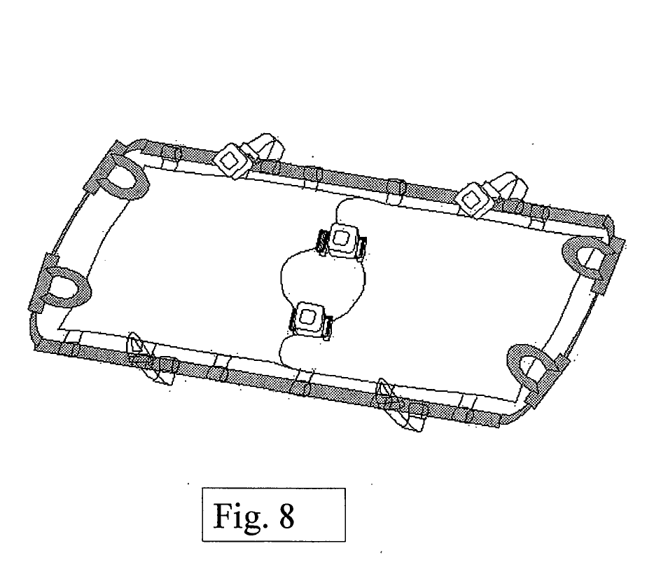

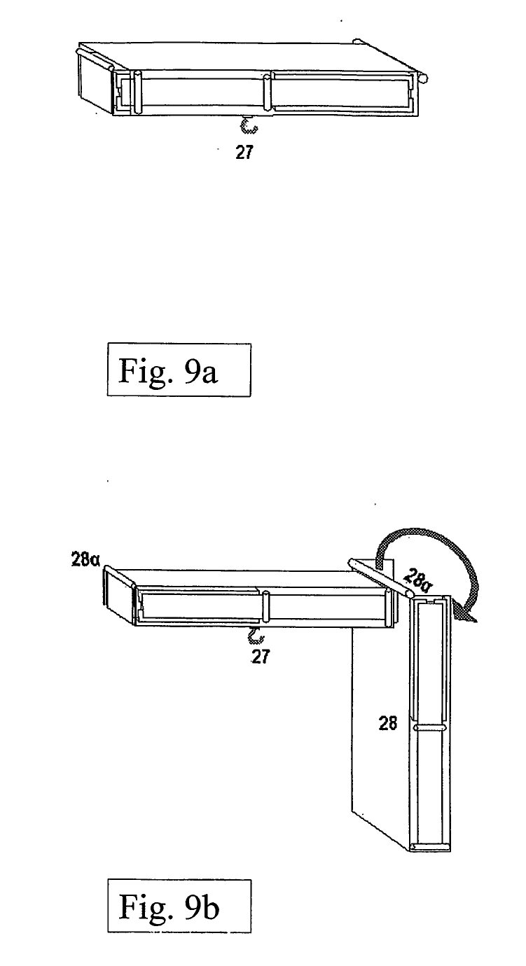

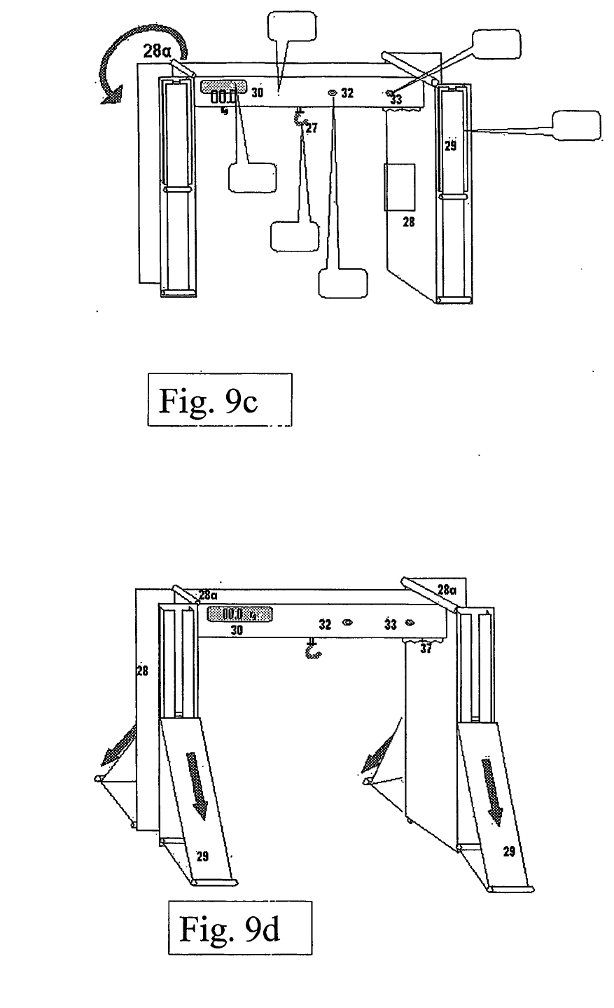

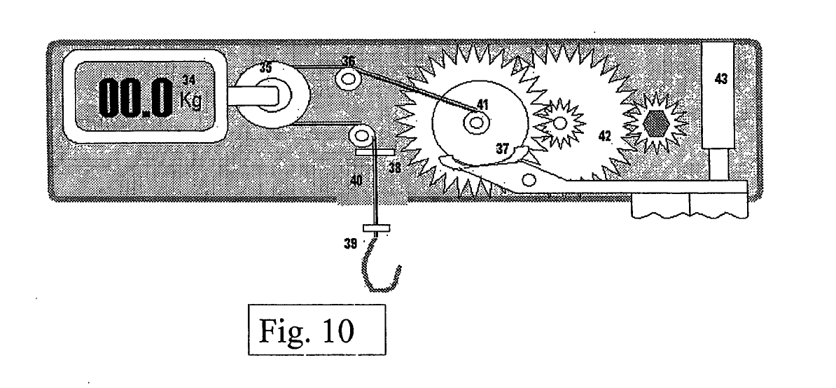

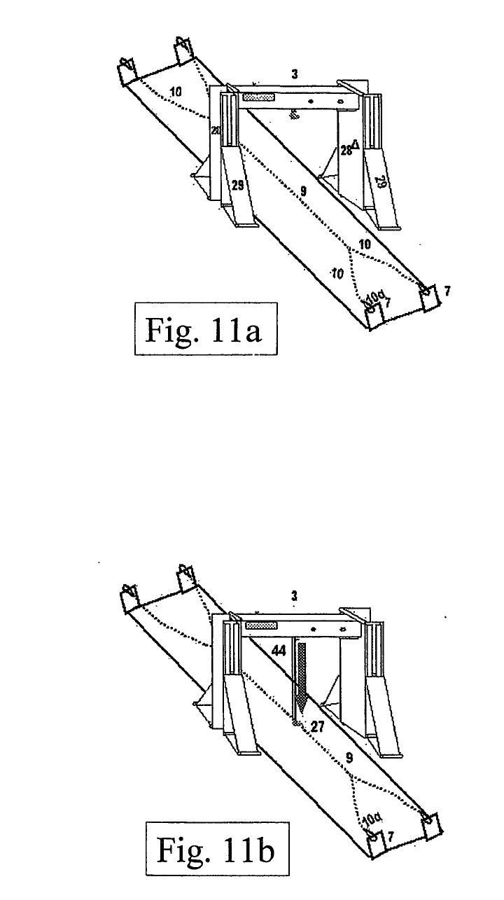

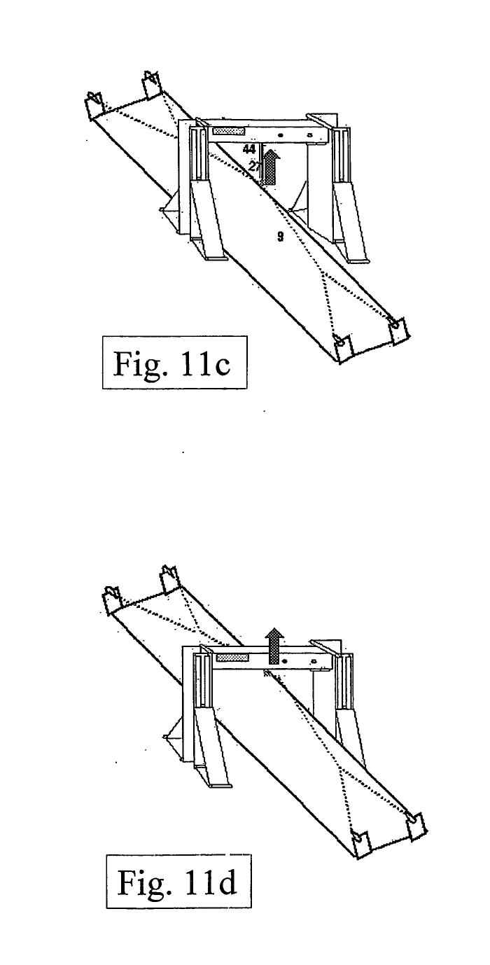

In FIG. 5c, it can be seen how the tubing parts (13), that constitute the long sides of the tubing frame, are pulled out one from the other.

In FIG. 5d are seen the tubing parts (13a), (13b) and (13c), arranged as when taken out from the storage configuration: the tubing part with the smallest diameter (13c) taken out from the tubing part with the next greater diameter (13b) and the latter part taken out from the one with the next greater diameter (13a).

In FIG. 5e, it can be seen how the tubing parts (13a), (13b) and (13c) are positioned when they are assembled to form the long sides of the frame. That is, their order is reversed so that the smaller-diameter short projections of each part (15a, 15b) are inserted into the adjacent tubing part and secured, so forming a single frame.

In FIG. 5f, the complete form of the frame of the collapsible soft stretcher is seen.

FIGS. 6a, 6b, 6c and 6d show a system for securing the tubing parts of the collapsible frame.

FIG. 7a shows the soft surface of the stretcher, where the ribbon-like extensions (16) end in loops (17). The free ribbons (18) are shown with a loop on one end (19) and a male (20) or female (21) fastener at the other end.

FIG. 7b shows the soft surface of the stretcher in a break-apart version consisting of two parts I and II. Also shown here are the ribbon-like extensions (16) with a loop on one end (17), and in (18) the free ribbons with a loop on one end (19) and a male (20) or female (21) fastener at the other end. In (22) a crescent-shaped recess in each part of the soft surface is shown, in (23) loops are shown and in (24) tongue-like extensions of the soft surface that can be connected together, e.g. by Velchro material. In (25) are shown female fasteners and in (26) male fasteners, which are mounted on the loops (23) for connecting the two parts (1) and (II) of the soft stretcher.

FIG. 7c shows the fasteners (25) and (26) mounted on the loops (23).

FIG. 7d shows how the fasteners (25) and (26) have been secured and consequently how they have connected the two parts (1) and (II) of the soft stretcher.

FIG. 8 shows the complete form of the collapsible soft stretcher, in one of the two proposed versions of the soft surface, i.e. the one that breaks apart into two connectable parts, which is proposed by one embodiment of the present invention.

FIG. 9a shows the weighing beam (3) in storage configuration and the hook (27) that projects and constitutes one way of proposed connection of the cable of the weighing beam with the strap.

FIGS. 9b and 9c show first the one and then the other of the support members (28) of the weighing beam opening and rotating sequentially by 270 degrees around their joint, which is seen in (28a).

FIG. 9d shows the appearance of the weighing beam with the support members and their stabilising bases in full expansion. (28) shows the collapsible support members of the weighing beam in fully expanded (final) operating configuration and (29) shows the collapsible stabilising bases of the support members, fully expanded, as they are in operating configuration. (30) shows a readout for the dynamometer measurement. (31) shows a lever for controlled braking. A release button (32) of the mechanism allows for the cable to be pulled freely out of the weighing beam. A female receptacle (33) (preferably Allen-type) serves for connecting with the actuation mechanism.

FIG. 10 shows the interior of the weighing beam in a preferred embodiment of the invention, which comprises: dynamometer, preferably with a digital display (34), dynamometer pulley (35), pulleys for adjusting the direction of the cable (36), braking system (37), exit aperture for the cable (38), safety disc for the hook (39), cable (40), pulley for winding up the cable (41), toothed-wheel system (42), spring (43) for supporting the lever for controlled braking.

FIG. 11a shows the stretcher with the suspension strap (9, 10) fastened at the fastening loops (7) thereof, while a ready-to-use weighing beam (3) is positioned on its support members (28) astride the stretcher.

Continuing from the previous figure, FIG. 11b shows the cable (44) with the hook (27) being pulled down, so that the hook is joined to the suspension strap (9).

Continuing from the previous figure, FIG. 11c shows the cable (44) being pulled-up into in the weighing beam, lifting the stretcher by the suspension strap (9) which is connected to the cable by the hook (27).

Continuing from the previous figure, FIG. 11d shows the stretcher being lifted and suspended from the hook in position for weighing the patient on the stretcher.

### DESCRIPTION OF THE INVENTION

The weighing system of the present invention in principle comprises a stretcher, which is assembled under the patient, while lie is still lying (in horizontal position). Several kinds of stretchers can be used as long as they are easy to use, easy to position under the patient while lie is still lying and are light-weight for easy transport.

It should be possible to secure the patient onto the stretcher during weighing, hi order to avoid his fall and injury. According to an embodiment of the invention, the stretcher is equipped with restraint straps, with which the patient is fastened before lifting.

A metallic stretcher which can be dismantled (scoop stretcher or shovel stretcher) as is commonly used for patient transporting can be used for the purposes of the present invention.

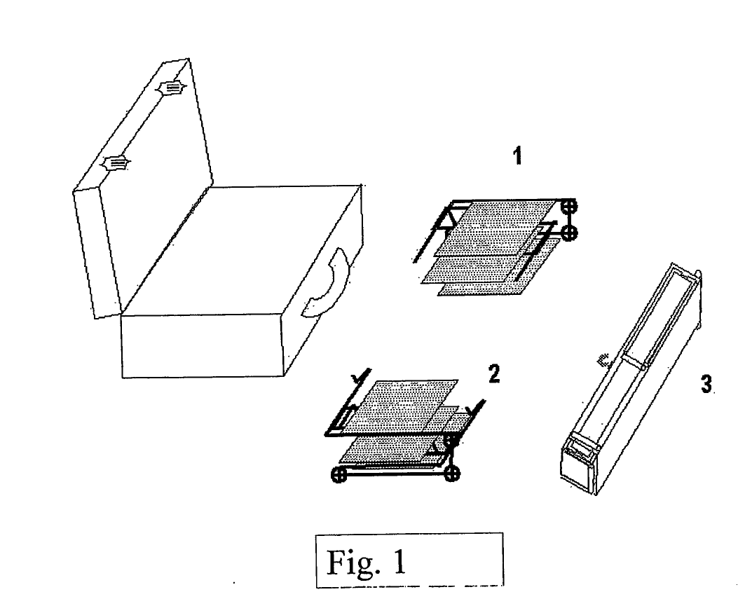

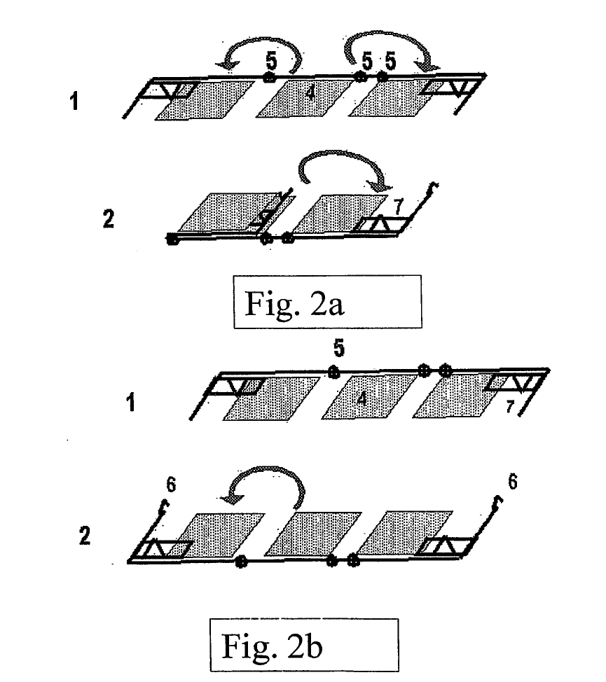

In a preferred embodiment of the invention, a metallic stretcher which can be dismantled is used in a foldable form. Such a stretcher makes the parts less bulky and particularly facilitates hie transport of the weighing system in a carrying case. The foldable metallic stretcher which can be dismantled has two long parts (1) and (2) as do other common dismantlable stretchers. Each long part (1) and (2) has at least one joint and can be folded into at least two parts. These joints also allow the alignment of the stretcher's parts and should be manufactured so as to prevent the folding of the stretcher when the patient is lying on it. Such a stretcher is illustrated in FIGS. 1 to 4, where in FIG. 1 the parts (1) and (2) are shown folded at their joints (in this particular illustration it has three joints in each part (1) and (2)). FIG. 2a shows how the joints are unfolded and in FIG. 2b both parts (1) and (2) are unfolded and aligned.

In any case, the foldable metallic stretcher proposed by the present invention, whether it is dismantlable or not, must be equipped with loops (7) for fastening the strap with which the patient on the stretcher will be suspended.

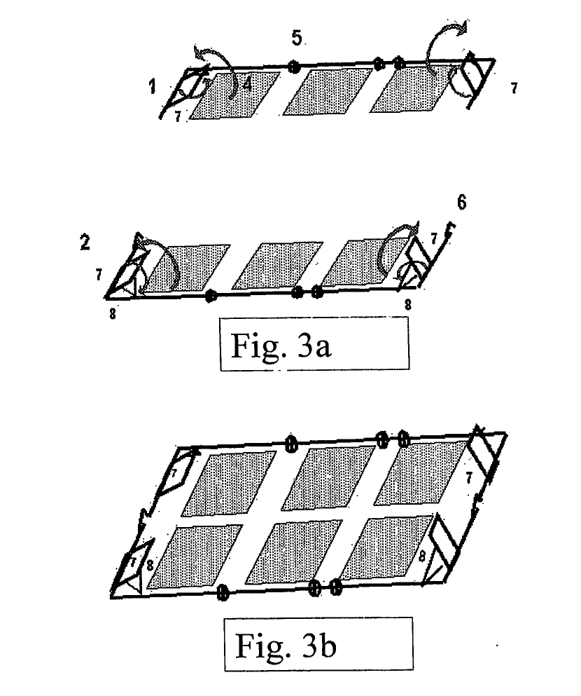

Preferably, these loops (7) are of semi-elliptical shape and are rotatable around each transverse tubing (of the short side-end) of the stretcher's frame, as illustrated in FIG. 3a. Preferably, there are four fastening loops (7), one beside each corner of the stretcher on the transverse tubing (of the short side) of the stretcher's frame, so as to balance the patient on the stretcher. These four loops (7) are illustrated in FIG. 3b.

The fastening loops must be stable and secure. In a preferred embodiment of the invention the fastening loops have counter-supports (8), as illustrated in FIGS. 3a and 3b. These counter-supports can be rotated around the outer vertical element of each fastening loop. At the lower point of each counter-support a female receptacle can be provided, that allows the secure and stable hinging of the counter-support on the adjacent long tubing of part (1) or part (2) of the stretcher. The hinging is such that it prevents the slippage of the counter-support and it also prevents the folding of the fastening loop towards the stretcher, when the loop is pulled towards it. This is achieved in that the plane defined by the loop is kept at an angle ca. 70-90° with respect to the plane of the stretcher. When the loop is pulled towards the opposite direction, the hinging is automatically released, and this allows the folding of the components (FIGS. 2a and 2b elements (7)) when the stretcher is disassembled after its use.

In another preferred embodiment of the invention, a collapsible soft stretcher is used, which may also be assembled under the patient who is to be weighed. Such a stretcher consists of at least the following different parts: a soft surface and a frame that may be assembled.

The soft surface is preferably orthogonal in shape and is made of soft material (e.g. tough fabric or synthetic), which allows it to be very easily stored and transported. Such a soft surface is shown in FIG. 7a.

Preferably, this surface has along its long sides ribbon-like extensions (FIG. 7a, element (16)), with a loop on one end (FIG. 7a, element (17)). The loops are provided for the tubing frame that may be assembled to pass through them.

In another embodiment of the invention the soft surface can also be of a break-apart type (dismantlable). Such a soft surface is shown in FIG. 7b. In this case the soft surface consists of two parts, (I) and (II) as shown in FIG. 7b. The shape of each part is approximately orthogonal. Preferably, each part, at one of its two short sides, has a crescent-shaped recess (22), which faces the corresponding recess (22) of the other part, which thus, forms a gap that corresponds to the buttock area of the patient. Adjacent to the crescent-shaped recess there are loops (23). In a preferred embodiment of the invention, these loops are metallic. The tongue-like extensions (24) of the soft surface parts have surfaces that are suitable to be connected to each other. In a preferable embodiment of the invention, these surfaces are made of Velcro.

The two different parts of the stretcher must be secured stably to each other, in order to hold the patient's weight. One way of securing the two different parts of the stretcher is shown in FIG. 7c. In particular, male (25) and female (26) fasteners are mounted on these loops (23). Each fastener may have a hook for it to be securely mounted to the loop.

When the surface is of a break-apart type, the main advantage is that this allows the easy positioning of the two parts under the patient's body and in particular by one person only, in the cases that it is undesirable, or inappropriate to roll the patient on the mattress or when the operator is not familiar with this technique. In this situation, the operator would lift the upper part of the patient's body by using his hips as fulcrum, so that the one part of the break-apart soft surface is positioned under his back, while the other part is positioned likewise under his legs. Alternatively, the rolling of the patient towards each side respectively is a technique that is indicated for the positioning of the single (non-break-apart) soft surface under the patient's body; this is the same technique that is usually used in order to change the bed sheets of a patient that cannot stand.

In a preferred embodiment, the soft surface is supplemented by free ribbons (18) as illustrated in FIGS. 7a and 7b, among others. These ribbons have loops on one end (19) and male (20) or female (21) fasteners on their other end. The long sides of the frame are passed through the loops (19) of these free ribbons, so that these ribbons serve as safety belts for securing the patient on the stretcher. This final form of the collapsible soft stretcher is illustrated in FIG. 8. In another preferred embodiment the ribbons that have fasteners on their end and serve as safety belts, are not free, but are extensions of the ribbon-like extensions beyond the loops.

When the frame of the dismantlable soft stretcher is in its assembled form, it has an orthogonal shape, its long sides pass through the loops (19) of the soft surface and through the corresponding loops (19) of the safety belts, when the latter exist as an option, as illustrated also in FIG. 8.

Preferably, the short sides of the frame (FIG. 5b, elements 11 and 12) are not of break-apart type and have loops (7) for fastening the strap, just like the metallic break-apart stretcher. In a preferred embodiment, the short sides end in quadrantal or orthogonal parts, the free ends (15) of which are intended for receiving the assembled long sides of the stretcher.

In a preferred embodiment, the long sides of the tubing frame which may be assembled consist of tubing parts of various diameters (FIGS. 5a to 5f in elements 13). Each tubing part, (as shown by 13a in FIG. 5d), has an inner diameter greater than or equal to the outer diameter of the next narrower tubing part (13b), so that when it is in storage configuration, the narrower part is inside the lumen of the next wider one, and so on. This means that all parts can be contained inside the widest among them, as illustrated in FIG. 5e.

In another preferred embodiment, the long sides have a telescopic arrangement. The narrower parts, that are contained inside the wider ones when they are in storage configuration, are pulled out of them and are secured in a position where the stability of the stretcher is ensured. This is necessary, because during operation of the scale, strong forces are applied to the long sides of the frame, which tend to retract the expanded “telescopic” parts.

The parts can be tubular or orthogonal cross-section (bent).

Preferably, in the case that the long sides are tubular, each part has at one of its ends (blind or open) a short extension of a few centimeter in length, the outer diameter of which is smaller than or equal to the inner diameter of the next narrower part, so that, when inserted into the latter, the extension connects the two parts between them. These extensions are illustrated especially by elements (15a) and (15b) in FIG. 5e.

From the storage configuration in which each tubular part is contained within the wider one, these tubular parts are pulled out and positioned in the opposite order, that is with their short extensions against the lumens of the narrower parts (FIG. 5e), into which the extensions will be inserted in the assembled form. In FIGS. 6a, 6b, 6c and 6d are illustrated details that provide an example of securing such a connection.

Before the final assemblage the tubular long-side parts pass through the loops of the ribbon-like extensions of the soft surface and the corresponding loops of the safety belts.

Advantages of the proposed collapsible soft stretcher, irrespective of the type of the stretcher, are that it is light, cheap, easy to fabricate and when it is in its storage configuration it occupies a small space. Further, the soft surface that comes into contact with the patient, may be washed, sterilized or disinfected, according to the operation requirements of the unit that uses it. Also a number of different soft surfaces may correspond to each scale, which allows each patient to have his own soft surface for weighing.

For the stretcher to be suspended, a suspension strap is used.

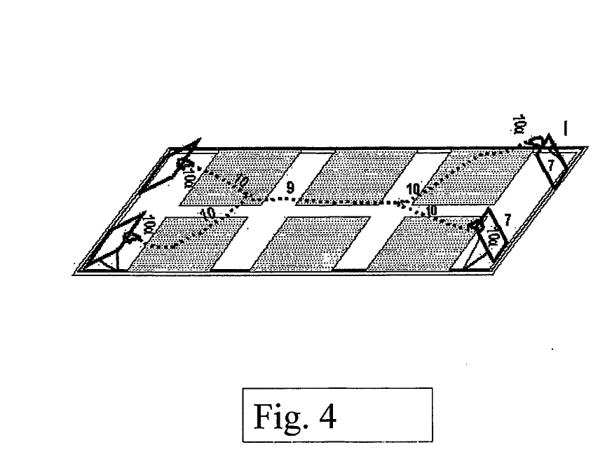

In a preferred embodiment of the invention, the suspension strap consists in principle of a central long element, which is in principle shown under (9) hi FIG. 4. In a preferred embodiment of the invention, the strap is preferably made of material that meets the following requirements:

a. it is rugged,

b. it is flexible,

c. it can withstand tension T at least equal to

$$T \geq k \frac{B}{2 * çìö} ,$$

where ö stands for the angle of the strap, when stretched, in respect to the plane that is defined by the stretcher, B stands for the maximum weight of the patients being weighed and k for the safety factor,

d. it should have high friction coefficient with the hook of the weighing beam, from which it is suspended,

e. it must be made of or lined with a soft material which protects the patient from injury, in case it comes in contact with uncovered parts of his body.

f. it should have sufficient length so as to allow its suspension from various points, so that the vertical projection of the suspension point during each weighing, lies near the vertical projection of the center of gravity of the system patient-stretcher.

g. it should be easily disinfected.

Also, in a preferred embodiment of the invention the suspension belt also comprises members that are seen as (10) in FIG. 4. These members are made of the same material as the central long element. It is desirable that these members have sufficient length so as to ensure that they are apart from the head, the chest and the lower limbs of the patient being weighed.

Also, in a preferred embodiment of the invention, the suspension strap comprises also safety hooks (FIG. 4 element (10a)). These hooks are located at the free ends of the members of the suspension strap (10) and are provided for the attachment of the strap on the fastening loops. Preferably they have locks that prevent the accidental disengagement from the suspension loops of the stretcher.

Preferably, the total length of the central long element and of the belt's members should be such, so that when stretched during suspending, the suspension point is as near as possible to the patient's body.

The main accessory of the proposed on-bed human scale (weighing system) is the weighing beam (3). Its further accessories, in a preferred embodiment of the invention are:

1. Casing made of tough material; in a preferred embodiment it is made of metal (e.g. aluminum), or of other similarly tough material. This casing is shown folded in FIG. 9a. In FIG. 9b the one support member (28) is unfolded, while in FIG. 9c the second support member (28) of the weighing beam is also unfolded.

2. Readout for the dynamometer measurement (e.g. on a liquid crystal display), which is shown as (30) in FIG. 9c.

3. Cable with hook. The hook is shown as (27) in FIGS. 9a, 9b, 9c, and is at the tip of the cable (40), the main body of which is inside the weighing beam.

4. Button for releasing the mechanism, which is shown in a preferred embodiment of the invention as (32) in FIGS. 9c and 9d. By pressing this button, the mechanism of the weighing beam is released and the free pulling of the cable (40) is allowed, to such a length so as to be joined with the suspension strap (9).

5. Receptacle of the actuation mechanism, which is shown as (33) in FIGS. 9c and 9d. In a preferred embodiment this is an Allen-type female receptacle, on which is applied the actuation mechanism; in an embodiment of the invention the latter is an external dectrically driven (e.g. rechargeable) screwdriver.

6. Lever for controlled braking, which is shown as (31) in FIG. 9d. By pressing this lever, a controlled raising of the mechaniism's braking is effected, so that, after weighing, the stretcher with the patient are lowered slowly back to the surface of the bed.

7. Joints of support members, which are shown as (28a) in FIG. 9d.

The inner part of the weighing beam is shown in FIG. 10, and comprises preferably the following components:

1. Dynamometer, preferably digital, which is shown as (34) in FIG. 10. Preferably, it should have sensitivity smaller or equal to 200 grams and weighing capacity at least 150 kg. Preferably, it should also have the following features:
a. storing the results of multiple measurements in storage memory
b. assignment of the measurements to codes or the names of the patients
c. automatic calculation of the body mass index

$$( BMI = \frac{B}{{h}^{2}} ) ,$$
where B is the body weight and h the height.
d. connecting and sending data to PC, pocket calculator or mobile phone (e.g. through infrared port).

2. Dynamometer pulley which is shown by element (35) in FIG. 10.

3. Pulleys for adjusting the direction of the cable, which are shown as (36) in FIG. 10. They ensure the parallel direction of the parts of the cable that come into immediate relation with the dynamometer's pulley (35).

4. Braking system, an embodiment of which is shown as (37) in FIG. 10. It allows that, for the winding up of the cable the pulley rotates in the same direction as it winds up in the pulley. Rotation of the pulley in the opposite direction is free only when the lever for controlled braking is pressed.

5. Exit aperture for the cable, which is shown as (38) in FIG. 10. It is a stable element fixed on the external casing and has an opening, through which the cable (44) passes. Against this element, the safety disc (39) for the hook is blocked, so as to prevent its further pulling into the weighing beam. Preferably, the aperture's position should be such flat at the end of its path the hook lies completely inside the casing of the weighing beam, and does not impede the positioning of the weighing beam in the carrying case.

6. Safety disc for the hook, which is shown as (39) in FIG. 10. It is a disc stably mounted above the hook, with diameter greater than the diameter of the exit aperture of the cable.

7. Cable, which is shown by element (44) in FIG. 10. It should withstand tension T′=k*B where B is the weight of the system patient-stretcher and k safety factor.

8. Pulley for winding up the Cable, which is shown as (41) in FIG. 10.

9. Toothed-wheel system, which is shown as (42) in FIG. 10. This ensures the relation between the rotation rate of the initial toothed wheel which is actuated by the electrical screwdriver and of the final toothed wheel on which the pulley for winding up the cable is mounted. As a results very slight muscle effort from the operator ensures the pulling-in of the cable and the lifting of the system patient-stretcher, with a speed of approximately 2-5 cm/sec, for example.

10. Spring for supporting the lever for controlled braking, which is shown as (43) in FIG. 10. The spring's function is to maintain and bring the lever for controlled braking back to its non-braking position.

The most important element of the present invention is that the weighing beam has support members that are positioned on top of the surface of the patient's mattress.

In an embodiment of the invention, which facilitates the storage and the transport of the proposed scale for humans, these support members are collapsible.

In an embodiment of the invention, these collapsible support members, seen as (28) in FIGS. 9b, 9c and 9d, may be metallic parts of [symbol] -shaped cross-section, joined with the weighing beam by the joints (28a) of the support members and are rotatable around these joints in 270° circular sectors. In the storage configuration these collapsible support members (28) are in positions parallel both to each other to the weighing beam, contained one within the other, as shown in FIG. 9a. In the operational arrangement of the scale, the collapsible support members are opened out, by rotating each one by 270°, into a position perpendicular to the weighing beam and connected with that by safety connections. An example of such connections is shown in FIG. 9d as (28a). The free end of each member of [symbol] necessarily terminates in a base that, in the operational arrangement of the scale, is positioned on top of the mattress, astride the patient, parallel to and outside each long side of the stretcher. The bases serve both for the stabilization of the weighing mechanism, and for blocking the excessive lowering of the scale's vertical members into the mattress. In a preferred embodiment each base is collapsible. These collapsible bases are shown by element (29) in FIG. 9d.

In a preferred embodiment, each base consists of four metallic plates (two on each side), the sum of the lengths of each pair not exceeding the vertical member's length. The plates of each pair are jointed between them with a free joint, while the lower plate of each is stably jointed with the end of the member. The upper point of the upper plate has a stable T-shaped component, the projections (arms) of which slide in opposing guides on the sides of the support member. When the system is in storage configuration, the metallic plates of each collapsible base are in contact with the support member on which they are mounted, on the plane defined by [symbol] , as shown in FIG. 9c. As the joints connecting the plates of the collapsible stabilizing bases are pulled outwards vertically to the plane defined by [symbol] , the free arms of the T-shaped components slide downwards in the guides where they are positioned, so as to stop at their lower end and be stabilized there securely, as shown in FIG. 9d. In expanded configuration the support bases are in such a position that the lower plates, jointed with the support members, may form right angles with the latter. The two lower plates of the bases of each member in expanded configuration (vertical to the support arm and to the plane defined by [symbol] ), form a surface that lies on the patient's mattress and supports the scale.

For suspending the patient and especially for actuating the suspension mechanism, in a preferred embodiment of the invention, the use of an electric screwdriver, which may be rechargeable, is proposed. This use has the following advantages:

1. The minimum necessary volume of the weighing beam is decreased.

2. The motor is independent of the scale and so:
a. It can be repaired or replaced easily in case of malfunction.
b. The electric batteries are in the screwdriver away from the weighing beam, so recharging is easy.
c. The operator can select various types of electric screwdrivers with various horse powers.

3. There may be several spare motors in case of malfunction or early discharging.

However, the manufacturer may decide to mount the motor hi the weighing beam.

In another version, the energy needed for lifting the stretcher and the patient can be derived from a pressurized gas cylinder (gas sprint) mounted within the weighing beam. In order to bring the cylinder back to the previous (pressurized) condition, so that it is ready for the next weighing, various mechanisms, manual (levers) or electrically driven, can be used, at a time different from the one in which the weighing of the patient is effected. Thus, the weighing of the patient is facilitated and sped up, while the number of activities and tools used over the patient is decreased.

### EXAMPLE OF REALISATION OF THE INVENTION

First of all, the components are taken out of the carrying case.

The assemblage of each of the proposed kinds of stretchers under the patient is effected as follows:

In the case of the collapsible soft stretcher, the operator rolls the patient's body on the mattress towards the opposite side and positions the soft surface on the free area of the mattress, so that its longer median line corresponds to the middle line of the patient, when the latter is allowed to return to his supine position. It is understood that in order to put the soft surface in this position, the one half of the surface, facing the patient, should be appropriately compressed (folded, rolled or gathered). Thereafter, the patient is rolled to the opposite side and the compressed part of the soft surface is expanded. Finally, the patient is left to return again to his supine position, so that lie is lying on the soft surface and on its center line.

When the soft surface is of break-apart type, the operator uses one hand to lift the upper half of the patient, using the patient's lips as fulcrum, and positions the one part of the soft surface underneath, with the crescent-shaped recess (22) positively-fit at his buttocks. Thereafter, the other half of the soft surface is positioned in the same way under the lower limbs of the patient. The fasteners (25, 26) are mounted oil the metallic loops (23). The female (25) and male (26) parts of the fasteners are connected to each other and secured. This activity causes parts (I) and (II) to come closer together. Thereafter, the tongue-like surfaces (24) are placed one on top of the other, so that the Velchro surfaces are attached.

After the patient is placed on the soft part of the stretcher, then the tubing parts of the frame are expanded, are passed through the loops (17) in the correct order as previously described and are hinged between them, in order to form a stable and rigid frame. Alternatively, the telescopic long sides of the frame are stretched and joined with the short sides.

In case of a metallic break-apart stretcher, the positioning of the patient on the stretcher is effected as follows:

The two parts (1) and (2) of the collapsible break-apart stretcher are unfolded and placed expanded on the bed, beside the patient.

1. The parts (1) and (2) are pushed slightly so as to slide under the patient. If needed, the patient is pushed slightly in order to roll by 30-40 degrees in the same direction.

2. The joints (6) are secured between the two parts of the stretcher (1) and (2).

3. Thereafter are lifted the fastening loops (7) and the counter-supports (8), which are attached on the adjacent tubes of the stretcher.

According to the above and irrespective of the kind of the stretcher, once the patient is on the stretcher and is fastened stably on that, then the suspension strap (9, 10) is fastened with the safety hooks (10a) on the suspension loops (7) that are fixed on the frame of each stretcher and is left lying loose on the patient.

Thereafter, the support members (28) and bases (29) of the weighing beam are opened and secured in the expanded configurations with proper mechanisms.

Then, the weighing system (weighing beam, support members, stabilizing bases) is placed astride the patient, with the support bases on top of the mattress, positioned parallel to the stretcher, in a position that is supposed to be at the centre of gravity of the patient.

Thereafter, the release button (32) is pushed and the hook (27) of the cable is pulled, so as to approach the suspension strap (9). The suspension strap is inserted in the hook of the cable. The electronic dynamometer is switched on (ON). The tip of the screwdriver is inserted in the receptacle of the actuation mechanism and the mechanism is switched on.

When the stretcher is suspended to such a height that none of its points touches the bed, then the dynamometer measurement is read.

In an other version the dynamometer does not sense forces right from the beginning, so as to avoid its overloading when the lifting commences. Its loading takes place during the rest phase of the system, when the cable tension is transmitted to it by suitable lever mechanism.

After the weighing is completed, the lever (31) for controlled braking is gently pushed, so that the patient comes down smoothly on his bed. Afterwards, the hook (27) of the cable is released from the suspension strap (9) and the weighing means (weighing beam, support members, stabilizing bases) is removed from the patient. The suspension strap is disconnected and removed from the patient and the stretcher. The stretcher is dismantled and its parts removed from the patient's bed.

Finally, the various parts of the weighing system are packed and placed back in the carrying case.

During actuation of the suspension mechanism if it is realized that only one end of the stretcher is lifted, while the other remains in touch with the bed, then the lever for controlled braking (31) must be gently pushed, so that the patient comes down smoothly on to his bed, the hook (27) of the cable is slightly moved towards the end of the stretcher that remained in touch with the bed and the procedure is repeated from the step of actuating the suspension mechanism.

For the safe weighing of the patient with the proposed weighing system the following measures are suggested:

Before use, the operator must check that:

a. The weighing means (weighing beam, support members, stabilizing bases) has been secured in the stretched configuration.

b. The bases (29) are supported at stable points of the mattress and there is no possibility that these will slide out of position.

c. The various parts of the suspension strap (9, 10) are at a safe distance from the parts of the patient's body during suspending.

d. The patient is fastened on the stretcher with safety belts before lifting.

e. The weighing means (weighing beam, support members, stabilizing bases) is placed in such a way so that the receptacle of the actuation mechanism is on the side opposite to the patient's head. Thus the possibility of injuring the patient is minimized, should, during operation, the screwdriver become disengaged and fall on the patient.

Furthermore, all the components of the scale for humans must be disinfected after each use and before using with the next patient or clean, disposable covers or multiple-use covers should be used.

Also, the dynamometer should be checked regularly, by weighing a known weight; it is also suggested that the rechargeable batteries should be recycled after the end of their lifetime.

In another embodiment of the invention, the stretcher is suspended from a cable, which comes out of the bottom side of the weighing beam and which on the inside of the beam passes over a stable point connected to the dynamometer. As the cable is retracted into the weighing beam, its free end is drawn upwards. The retraction is effected over pulleys which guide the cable and is driven by circular motion provided by an electrical power source, in one preferred embodiment, or if another energy source is used, by one or two pistons.

In a preferred embodiment of the invention, electrical drive is used (for retraction of the cable, i.e. lifting of the stretcher). In another embodiment, a compressed gas may provide the power. The compressed gas might come from a source placed on the floor and separate from the weighing mechanism, or from bottled compressed oxygen or from a source of compressed air as found in most modern hospital rooms.

Such compressed air containers, may be used also for inflating inflatable stretchers.

In a preferred embodiment of the invention, the scale's support members are folded into the bottom surface of the weighing beam. When drawn outward, they open and are secured in operating position by counter-supports/braces.

1. Weighing system for measuring the body weight of a patient lying in a horizontal/bed-top position, which comprises:
a stretcher,
a strap for suspending the stretcher and
weighing means,
characterized in that the weighing means are placed on top of the surface on which the patient is lying.

2. Weighing system according to claim 1, wherein the weighing means comprise weighing beam which has support members, the support members comprising stabilizing bases.

3. Weighing system according to claim 2, wherein said support members are parts with D-shaped cross-section made of tough material and rotatable around the joints of said support arms in circular sectors.

4. Weighing system according to claim 2, wherein the support members and the stabilizing bases of the weighing beam are collapsible.

5. Weighing system according to claim 1, wherein the stretcher is a metallic stretcher, the frame of which has points for fastening the suspension belt, preferably four in number.

6. Weighing system according to claim 5, wherein the fastening points of the stretcher have counter-supports.

7. Weighing system according to claim 4, wherein the stretcher is collapsible.

8. Weighing system according to claim 4, wherein the frame of said stretcher can be dismantled in two or more parts.

9. Weighing system according to claim 1, wherein the stretcher's surface has preferably orthogonal shape, is soft and made of fabric or synthetic material.

10. Weighing system according to claim 9, wherein the soft surface of said stretcher can be dismantled in more than one part.

11. Weighing system according to claim 1, wherein the suspension strap has central long part and members, the end of each arm attaching at the fastening points and having safety hooks.

12. Weighing system according to claim 11, wherein the suspension belt is made of flexible, soft and rugged material, with high friction coefficient.

13. Method for measuring the body weight of a patient lying in a horizontal/bed-top position, by using the system as claimed in claim 1, which comprises:
assembling the stretcher under the patient,
positioning the weighing means astride the patient and near his center of gravity and
suspending the stretcher with the patient by using suspension straps,
characterized in that said weighing system is positioned on the surface on which the patent is lying.
